(19) United States
(12) Patent Application Publication
(10) Pub. No.: US 2004/0119592 A1
(43) Pub. Date: Jun. 24, 2004

(54) Container for wafer-like objects

(76) Inventors: Sven Hahn, Wachau (DE); Gregor Kuebart, Dresden (DE); Michael Lering, Dresden (DE)

Correspondence Address: BAKER & BOTTS, 30 ROCKEFELLER PLAZA, NEW YORK, NY, 10112

(21) Appl. No.: 10/652,170

(22) Filed: Aug. 29, 2003

(30) Foreign Application Priority Data
Aug. 30, 2002 (DE) 102 40 771.1

(51) Int. Cl. G08B 13/08; E05C 5/00

(52) U.S. Cl. 340/545.6; 292/68; 340/10.1

(57) ABSTRACT

A container for wafer like objects includes a container body and a door closing the container body and which is provided with a device for locking and unlocking the door, including locking elements and holding elements in which the locking elements that lock the door engage. At least one locking element includes a first signal element which is operatively connected to a second signal element arranged at a position important for the engagement of the locking element in the holding element.

### BACKGROUND OF THE INVENTION

The invention relates to a container for wafer-like objects, comprising a container body, a door closing the container body and a device for locking and unlocking the door which, in turn, has locking elements and holding elements in which the locking elements that lock the door engage.

During the production of semiconductor components, semiconductor wafers are subjected to a large number of intermediate treatment steps before they are separated to form the semiconductor components. During the production process, it is necessary to transport semiconductor wafers between the individual treatment stations. For that purpose, the semiconductor wafers are laid in containers which are closed. The transport is then carried out with the container closed. The semiconductor wafers remain in the container during a specific production time period but can also be transferred into other containers. The containers can thus also serve to keep or magazine semiconductor wafers.

Containers of this type can also be used in other sectors of industry in which other wafer-like objects have to be transported, for example during the production of flat-screen monitors.

Such a container for wafer-like objects is disclosed by DE 195 35 178 A1. This comprises a container body into which the wafer-like objects, in this case the semiconductor wafers, can be pushed, and a door. The container is provided with a device for locking and unlocking the door.

The device for locking and unlocking the door has locking elements which are arranged on the door, and a recess in the container body, into which the locking elements penetrate. The locking elements are connected to an actuating mechanism with which the locking and unlocking of the locking elements can be performed, preferably simultaneously for all the locking elements. This actuating mechanism comprises a rotary disc, on whose periphery displacement parts for the locking elements act tangentially. When the rotary disc is rotated, the displacement parts are displaced in such a way that the locking elements penetrate into the recesses during locking and are withdrawn from the recesses during unlocking. Both in the locked state, when the locking elements have penetrated the recesses, and in the unlocked state, when they have been withdrawn, the rotary wafer in each case assumes an end position in its rotary position. Provided on the rotary disc is a signal generator which permits these two end positions to become visible on the outside. Thus, assuming that the locking elements penetrate reliably into the recesses, a statement about the locking state can be made indirectly.

The disadvantage in this case is that the indication of the locking state is carried out indirectly. This is because, if the door has not been closed properly and therefore the locking elements, although they have been extended, have not penetrated the recesses, a locked state is indicated, but the door is not closed. During the transport of the container, it is therefore possible for inadvertent opening of the door to occur, which in turn can lead to detrimental consequences. This is because, firstly, the wafer-like objects in the interior of the container can be contaminated through an open door. Secondly, this can lead to the wafer-like objects sliding out. In addition to these disadvantages, which lead to workpiece damage, thirdly, personal injury cannot be ruled out, in particular when the transport of the containers is carried out overhead, for example at the ceiling of the working room. This is because if the wafer-like objects, in particular semiconductor wafers with a large diameter, for example 300 mm wafers, slide out of the container, the relatively thin wafers can cause dangerous cutting injuries if they slide or fall down.

It is therefore an object of the invention to prevent the transport of containers whose door is not securely closed.

### SUMMARY OF THE INVENTION

The object according to the invention is achieved in that there is arranged at least on one locking element a first signal element which is operatively connected to a second signal element on the holding element, which is arranged in a position important for the engagement of the locking element in the holding element. A signal element of this type can either be used for the simple indication of the locking state or for triggering a signal for further processing. In any case, the arrangement ensures that an indication or signal triggering is carried out when the locking element engages in the holding element. As opposed to this, for example in the case of an arrangement according to the prior art, it is possible for the locking elements to be broken or deformed, so that, although the operating mechanism for the locking element is in a locked position, the locking element itself does not engage in the holding element and thus lock the door effectively.

In addition, reference is made to the fact that at least one locking element is configured according to the invention. In this case, it is assumed that, in the event of proper locking of at least one locking element, the door is locked effectively. of course, it is also possible to equip several or all of the locking elements with signal elements. Accordingly, the security of the door locking is enhanced.

In one refinement of the invention, provision is made for the first signal element to be arranged in a region of the locking element resting on or in the door and for the second signal element to be arranged on or in the door. As a result of this refinement, the first signal element will enter an operative connection with the second signal element in the region of the door.

The second signal element may be designed as an opening in the outer side of the door. In this case, the first signal element consists of a signal plate which covers the opening in the position in which the locking element engages in the holding element. This embodiment represents a very simple solution which permits visualization of the closure state. This is because, if the first signal element covers the opening, the first signal element will become visible from outside through the opening., Since, in this case, the locking element is in the position in which the locking element engages in the holding element, this represents a reliable indication of the closure state.

In a refinement of this embodiment, provision is made for the opening to be closed transparently. On the one hand, there is the possibility that the signal plate itself will perform the closure of the opening. However, continuous closure of the opening is ensured by the transparent cover over the opening, so that particles cannot penetrate into the interior of the container whether the closed container is locked or not.

In a further refinement of the invention, provision is made for the first signal element to be arranged on a pawl which belongs to the locking element and engages in the holding element, and for the second signal element to be arranged on or in the holding element.

This embodiment represents a particularly reliable check on the closure state, since the first and second signal element are arranged directly where the pawl interacts with the holding element, and therefore the closure state is monitored directly at this point.

One simple embodiment can be achieved by the first signal element being formed by the pawl itself. This is achieved by the physical characteristics of the pawl itself being used to detect the closure state. These physical characteristics can be, for example, optical, magnetic or electric characteristics of the pawl.

In a further refinement of the invention, provision is made for the first or the second signal element to be designed as a sensor which in each case can be actuated by the other signal element. Such a sensor makes it possible for automatic detection of the closure to be implemented.

In this case, it is particularly expedient for the sensor to consist of an electric, magnetic, optical or Hall sensor. Here, for example by means of the sensor, the electric, magnetic, electromagnetic, optical or frequency-influencing characteristics of the respective other signal element are used to trigger the sensor. Here, too, there is the possibility that these sensors are triggered by the pawl itself. Of course, a special triggering element can also be provided. For this purpose, for example, the arrangement of a reed switch in the holding element and the arrangement of a permanent magnet on the pawl are possible, by which means the magnet on the pawl actuates the reed contact and therefore switches on a switching state which can be monitored electrically. In the same way, it is possible to operate with other types of sensors.

In an expedient refinement of the invention, the sensor is connected via a signal line to a signal output. An external control unit, can be connected to the signal output. The closure state of the container can be monitored automatically by the external control unit. If a container has not been closed properly, this is determined by the control unit and further measures are triggered. In the simplest case, these measures can consist in an indication or the emission of an alarm about a door closure failure.

In a further refinement of the invention, provision is made for the sensor to be connected via a signal line to a transponder, such as an RFID tag, which is arranged in the container or in the door and which can be read in a wire-free manner by means of a reading unit. Transponders are components which, by applying an electromagnetic alternating field, are firstly supplied with energy from this alternating field for the internal operation. Secondly, they are connected via the alternating field to the reading device, in which at least signals which are output by the transponder are transmitted to the reading unit via the alternating field. Signals of this type can be, for example, the storage contents of a storage unit in the transponder.

Such a transponder arrangement makes it possible for the state data relating to the closure state of the door to be stored in the container itself and read out in a wire-free manner via an appropriate reading unit. This embodiment is of interest in particular in installations in which the containers are transported automatically. Control units can then be arranged at various stations on the transport paths, where the control units contain a reading unit. The reading unit, reads the closure state of the container which is currently being transported. If a closure failure occurs, the transport operation can then be interrupted, or the enclosed container isolated.

The invention is to be explained in more detail below using an exemplary embodiment.

### BRIEF DESCRIPTION OF THE DRAWINGS

FIG. 1 shows a sectional illustration through a container according to the invention with a locking mechanism, along the inner side of the door.

FIG. 2 shows a front view of the container according to FIG. 1 with the door locked.

FIG. 3 shows a front view of the container according to FIG. 1 with the door unlocked.

FIG. 4 shows a schematic illustration of a container with optical sensors or sensors based on the Hall effect.

FIG. 5 shows a schematic illustration of a container with electromechanical sensors.

FIG. 6 shows a schematic illustration of a container with a transponder in the door, and

FIG. 7 shows a schematic illustration of a container with a transponder in the container body.

### DETAILED DESCRIPTION OF THE INVENTION

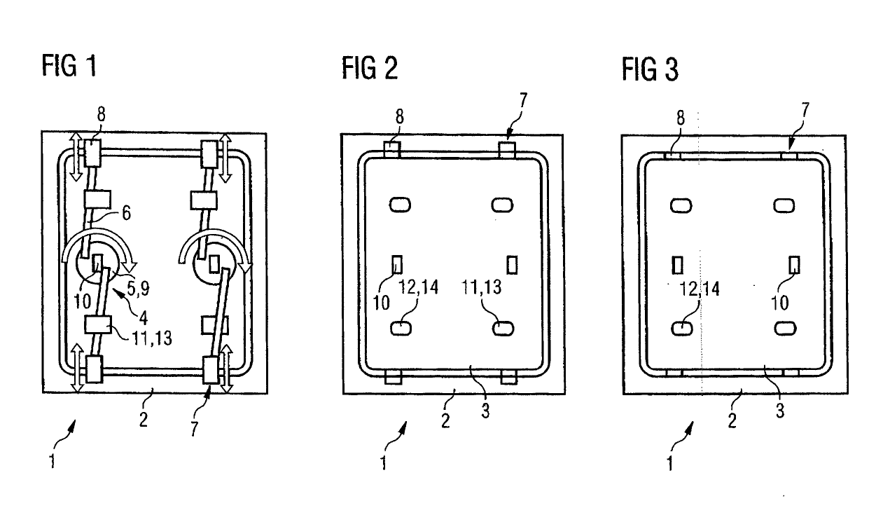

As all the figures illustrate, the container 1 according to the invention for wafer-like objects comprises a container body 2 and a door 3 closing the container body 2. As FIG. 1 illustrates, a locking mechanism 4 is also provided, which has an actuating mechanism 5 which acts on locking elements 6. Holding elements 7 are provided on the container body 2. Each locking element 6 engages with a pawl 8 in a holding element 7. The actuating mechanism 5 is designed in the form of a lock which has a disc 9 which is provided with a key receptacle 10. The disc 9 is mounted such that it can be rotated by plugging a key, not specifically illustrated, into the key receptacle 10. The locking elements 6 are attached peripherally to the disc 9. By means of rotation of the disc 9, the locking elements 6 are displaced tangentially with respect to the disc 9. By means of this displacement, which is expressed in a displacement running substantially in the longitudinal direction of the locking element 6, the pawl 8 is pushed into the holding element 7.

As can be seen from FIG. 1, two locking mechanisms 4 may be provided in a container 1 according to the invention. The locking mechanisms 4 each have two locking elements 6, which then engage with their pawls 8 in four holding elements 7. As also illustrated in FIG. 1, the locking elements 6 are provided with first signal elements 13 comprising signal plates 11. Second signel elements 14 comprising openings 12 are provided in the door 3. The openings 12 correspond with signal plates 11 in such a way that the signal plates 11 cover the opening 12 in the position in which the locking element 6 engages in the holding element 7. This state is illustrated in FIG. 2. If locking the door 3 in the container body 2 has not yet been carried out or has not yet been carried out properly, the signal plates 11 do not cover the openings 12 and, consequently, the signal plate 11 is not visible in the openings 12. This is illustrated in FIG. 3. Since the signal plates 11 are expediently provided with a colored marking on the side facing the door 3, in the state illustrated in FIG. 3 it becomes clear that locking has not yet taken place or has not taken place properly. Only when the state which is illustrated in FIG. 2, wherein signal plates 11 fill openings 12, has been reached is the door 3 locked properly in the container body 2. This becomes visible through the openings 12, through which the colored identification of the signal plates 11 appears. Consequently, an operator knows that proper locking has taken place and can release the container 1 for transport or perform this transport himself

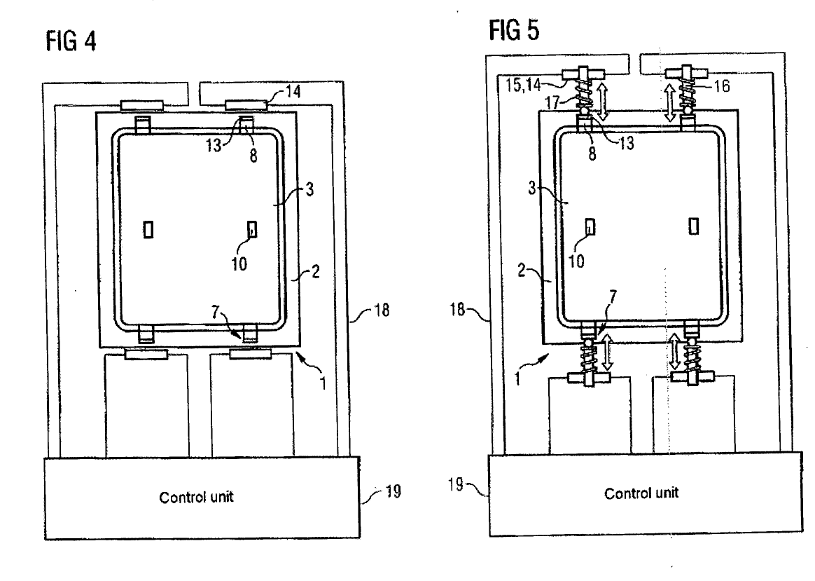

In the container according to the invention illustrated in FIG. 4, a first signal element 13 is fixed to the pawl 8. This first signal element has characteristics which excite a second signal element 14 which is arranged in the holding element 7. If the second signal element 14 on the holding element 7 are, for example, an optical sensor, the first signal elements could be constituted by highly reflective films. If the second signal element 14 are, for example, reed contacts, a magnet would be arranged on the pawl 8 as the first signal element 13. Of course, these characteristics of the first signal elements could also be performed by the pawls 8 themselves if the latter, for example, have adequate reflective or magnetic characteristics.

When the locking element 4 engages and, in this case, in particular when the pawl 8 engages in the holding element 7, the first signal element 13 reaches the vicinity of the second signal element 14, by which means the second signal element 14 is excited by the first signal element 13 by changing characteristics that can be used to output a signal.

The container arrangement illustrated in FIG. 5 operates in the same way and there, as second signal elements 14, has switching contacts 15 which are provided with contact-triggering elements 16. The contact-triggering elements 16 are actuated by the pawls 8 which, in this case, perform the functions of the first signal element 13. Therefore the contact-triggering elements 16 are forced upwards or downwards counter to the action of a spring 17 and in turn actuate the switching contacts 15. A switching function can therefore be triggered. As FIGS. 4 and 5 illustrate, the respective second signal elements 14 are connected via signal lines 18 to a control unit 19. By means of the second signal elements, a signal can thus be provided to the control unit 19 via the signal line 18. This signal can be used, for example, for the purpose whereby the control unit only permits transport of the container 1 if a corresponding locking signal is triggered by the first signal elements 13 and the second signal elements 14 and is provided to the control unit 19 via the signal line 18.

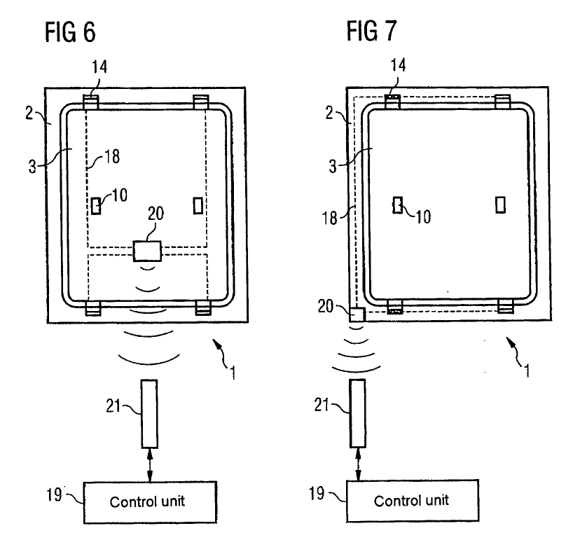

As FIG. 6 and FIG. 7 illustrate, the signal lines 18 are connected to a transponder 20. In this case, the transponder 20 is located either in the door 3, as illustrated in FIG. 6, or in the container body 2, as illustrated in FIG. 7. Via the signal lines 18, the switching state signals are provided to the transponder 20 and can, be stored in the latter. Via an external reading unit 21, such as an RFID reader, which can be arranged on the transport path of an automatic transport installation or at an appropriate receiving station, the contents of the transponder 20 and therefore the switching state signal can then be, read out.

While there have been described what are believe to be the preferred embodiments of the invention, those skilled in the art will recognize that other changes and modifications may be made thereto without departing from the spirit of the invention, and it is intended to claim all such changes and modifications as fall within the true scope of the invention.

We claim:

1. In a container for wafer-like objects, having a container body, a door closing the container body and a device for locking and unlocking the door including locking elements and holding elements in which the locking elements engage, the improvement wherein at least one locking element includes a first signal element which is operatively connected to a second signal element when the locking element is in a position important for the engagement of the locking element in the holding element.

2. The improvement specified in claim 1 wherein the first signal element is arranged in a region of the locking element which rests on or in the door, and the second signal element is arranged on or in the door.

3. The improvement specified in claim 2 wherein the second signal element is an opening in the outer side of the door, and the first signal element consists of a signal plate which covers the opening in the position in which the locking element engages in the holding element.

4. The improvement specified in claim 3 wherein the opening is closed transparently.

5. The improvement specified in claim 1 wherein the first signal element is arranged on a pawl of the locking element which engages in the holding element, and the second signal element is arranged on or in the holding element.

6. The improvement specified in claim 5 wherein the first signal element is formed by the pawl itself.

7. The improvement specified in claim 5 wherein one of the signal elements is designed as a sensor which can be actuated by the other signal element.

8. The improvement specified in claim 7 wherein the sensor is connected via a signal line to a signal output device to which a control unit can be connected.

9. The improvement specified in claim 7 wherein the sensor is connected via a signal line to a transponder, which is arranged in the container body or in the door and which can be read out in a wire-free manner by means of a reading unit.

10. The improvement specified in claim 7 wherein the sensor consists of a sensor selected from an electric, magnetic, electromagnetic, optical and Hall sensor.

11. The improvement specified in claim 10 wherein the sensor is connected via a signal line to a signal output device to which a control unit can be connected.

12. The improvement specified in claim 10 wherein the sensor is connected via a signal line to a transponder, which is arranged in the container body or in the door and which can be read out in a wire-free manner by means of a reading unit.
